(19) United States
(12) Patent Application Publication
(10) Pub. No.: US 2026/0349245 A1
(43) Pub. Date: Nov. 5, 2026

(54) CAMERA MONITOR SYSTEM WITH SELF-CLEANING SENSOR HAVING RETRACTABLE DOOR WITH WIPER

(71) Applicant: Stoneridge Electronics AB, Solna (SE)

(72) Inventors: Gabriel Lepage, Royal Oak, MI (US); Troy Cooprider, White Lake, MI (US)

(21) Appl. No.: 19/194,511

(22) Filed: Apr. 30, 2025

(51) Int. Cl. G02B 27/00; B60R 1/24; B60R 1/25; B60R 1/26

(52) U.S. Cl. CPC G02B 27/0006; B60R 1/24; B60R 1/25; B60R 1/26; B60R 2300/105; B60R 2300/802; B60Y 2200/148

(57) ABSTRACT

A CMS sensor assembly includes a base having tracks at opposing sides of an opening. A sensor is in a sensor housing within the base. An exterior lens is supported by the sensor housing and arranged over the sensor at the opening. A flexible shutter door is movably supported by the tracks to selectively block the opening and expose the exterior lens. A wiper is mounted to the door and slides between a closed position in which the door blocks the opening to enclose the exterior lens and the sensor within the base, an open position in which the door exposes the exterior lens and the door is stowed adjacent to the sensor housing within the base, and a wiping position arranged between the closed position and the open position. The wiper is configured to slide across the exterior lens when moving between the closed position and the open position.

### TECHNICAL FIELD

This disclosure relates to a camera monitor system (CMS) for use in a commercial truck or similar vehicle with a self-cleaning sensor feature.

### BACKGROUND

Mirror replacement systems, and camera systems for supplementing mirror views, are utilized in commercial vehicles to enhance the ability of a vehicle operator to see a surrounding environment. Camera monitor systems (CMS) utilize one or more cameras to provide an enhanced field of view to a vehicle operator. In some examples, the CMS covers a larger field of view than a conventional mirror, or includes views that are not fully obtainable via a conventional mirror.

In a typical CMS, there is a camera arm arranged on each of the left-and right-hand sides of the vehicle to provide Class II and Class IV views or similar views. Other cameras may be provided, for example, at the front of the tractor or on the trailer. A display is provided on the A-pillar on both driver and passenger sides to display the field of view for the camera arm on that side, simulating a conventional mirror. Additional displays may also be provided to illustrate other views.

Each camera arm uses at least one rear-facing camera assembly that provides the rear-facing views to the driver via displays located in the vehicle cabin. While the vehicle is parked and during operation, the cameras can be obstructed by rain, snow, ice and road debris. Obstructions can compromise the quality of the displayed view, which is particularly problematic where the CMS has entirely replaced mirrors.

Many proposed camera cleaning systems use complex motions to move an exterior lens relative to a wiper. Furthermore, the camera cleaning systems may require a relatively large outer housing to enclose the various components, which may increase weight and/or aerodynamic drag.

### SUMMARY

In one exemplary embodiment, a sensor assembly for a vehicle camera monitor system (CMS) includes a base that is configured to be mounted to a vehicle, the base has tracks at opposing sides of an opening in the base, a sensor housing that is arranged within the base, a sensor has a sensor axis and is arranged within the sensor housing and configured to provide a vehicle environmental monitoring signal to the CMS during vehicle operation, and an exterior lens is operatively supported by the sensor housing and arranged over the sensor at the opening, a flexible shutter door that is movably supported by the tracks and configured to selectively block the opening and expose the exterior lens, a wiper that is mounted to the door, and an actuator that is arranged in the base and configured to, in response to a sensor demand signal from the CMS, slide the door along the tracks between a closed position in which the door blocks the opening to enclose the exterior lens and the sensor within the base, an open position in which the door exposes the exterior lens, and the door is stowed adjacent to the sensor housing within the base, and a wiping position is arranged between the closed position and the open position. The wiper is configured to slide across the exterior lens when moving between the closed position and the open position.

In a further embodiment of any of the above, the door includes multiple discrete slats that are joined to one another at a joint that permits articulation between adjacent slats.

In a further embodiment of any of the above, the tracks have curved portions such that the tracks provide a non-linear path between the closed and open positions.

In a further embodiment of any of the above, the non-linear path includes transverse portions that are joined by the curved portions.

In a further embodiment of any of the above, the door is an opaque solid material without a window. The exterior lens is hidden and not visible behind the door when in the closed position.

In a further embodiment of any of the above, the sensor housing is fixed relative to the base.

In a further embodiment of any of the above, the sensor housing is configured to remain fixed in the open position, the closed position and the wiping position.

In a further embodiment of any of the above, the door has an end, and the wiper is arranged at the end.

In a further embodiment of any of the above, the base includes a switch that is configured to detect the end in the closed position.

In a further embodiment of any of the above, the sensor is one of a camera, a lidar sensor, a radar sensor or an ultrasonic sensor.

In a further embodiment of any of the above, the sensor assembly includes a washer system that includes an array of jets provided in the sensor housing about the exterior lens. The washer system has a pump and a fluid reservoir in fluid communication with the jets configured to provide a fluid to the jets to remove debris from the exterior lens.

In a further embodiment of any of the above, a CMS that includes the sensor assembly further includes a controller that is in communication with the actuator and the sensor. The controller is configured to move the door to the closed position when a vehicle is in a non-operational state.

In a further embodiment of any of the above, the sensor includes an image capture unit that is configured to provide at least one field of view, and includes at least one display configured to depict at least portions of the at least one field of view.

In another exemplary embodiment, a method of removing debris from a camera monitor system (CMS) sensor assembly includes providing sensor housing with a sensor arranged beneath an exterior lens, the sensor housing is arranged within a base that includes an opening, moving a flexible shutter door between a closed position and an open position, and sliding a wiper against the exterior lens in a wiping position while performing the moving step. The wiper position is arranged between the closed position and the open position.

In a further embodiment of any of the above, tracks that slidably support the door have curved portions such that the tracks provide a non-linear path between the closed and open positions, and the non-linear path includes transverse portions joined by the curved portions. The door includes multiple discrete slats joined to one another at a joint that permits articulation between adjacent slats along the non-linear path during the moving step.

In a further embodiment of any of the above, the door is an opaque solid material without a window. The exterior lens is hidden and not visible behind the door when in the closed position.

In a further embodiment of any of the above, the sensor housing is fixed relative to the base, and the sensor housing is configured to remain fixed in the open position, the closed position and the wiping position.

In a further embodiment of any of the above, the door has an end, and the wiper is arranged at the end.

In a further embodiment of any of the above, the base includes a switch that is configured to detect the end in the closed position.

### BRIEF DESCRIPTION OF THE DRAWINGS

The disclosure can be further understood by reference to the following detailed description when considered in connection with the accompanying drawings wherein:

FIG. 1 is a schematic front view of a commercial truck with a camera monitor system (CMS) having camera arms used to provide at least Class II, Class IV and Class VI views.

FIG. 2 is a schematic top view of a commercial truck with a camera mirror system illustrating Class II, Class IV, Class V, Class VI and Class VIII views.

FIG. 3 is a schematic top view of a vehicle cabin incorporating a CMS and including displays.

FIG. 4 illustrates an example Class VI camera housing and camera.

FIGS. 5A-5B illustrate a sensor door illustrating open and closed positions.

FIG. 6 is a schematic of the sensor door partially open and tracks, actuator and a drive connection shown in phantom.

FIG. 7 is an example camera lens spray system.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

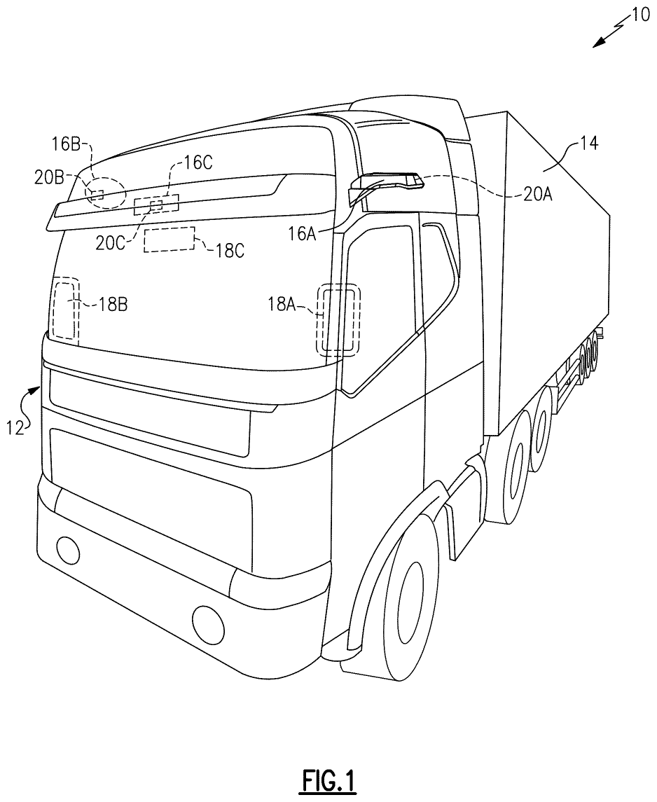

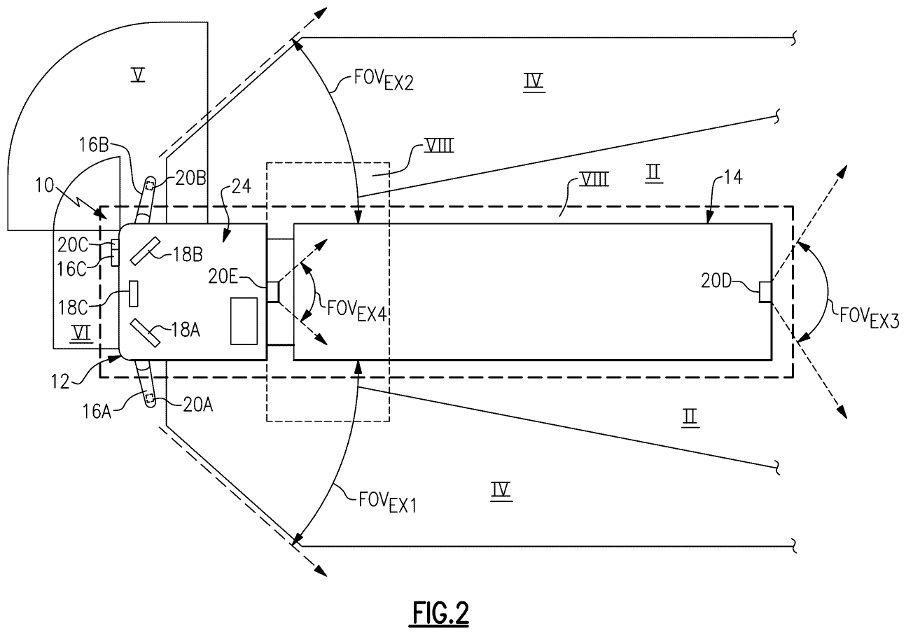

A schematic view of a commercial vehicle 10 is illustrated in FIGS. 1 and 2. The vehicle 10 includes a vehicle cab or tractor 12 for pulling a trailer 14. It should be understood that the vehicle cab 12 and/or trailer 14 may be any configuration. Although a commercial truck is contemplated in this disclosure, the invention may also be applied to other types of vehicles. The vehicle 10 incorporates a camera monitor system (CMS) 15 (FIG. 3) that has driver and passenger side camera wings or arms 16a, 16b (generally, “camera arm 16”) mounted to the outside of the vehicle cab 12. If desired, the camera arms 16a, 16b may include conventional mirrors integrated with them as well, although the CMS 15 can be used in some examples to entirely replace mirrors. In additional examples, each side can include multiple camera arms, each arm housing one or more cameras and/or mirrors.

As shown in FIG. 2, each of the camera arms 16a, 16b includes a base that is secured directly to, for example, the cab 12, using fasteners or other attaching hardware. A pivoting arm is supported by the base and may articulate relative thereto, if such a feature is desired. In the example, the camera arm 16 has a power fold feature in which an actuator is used to move the pivoting arm between a stowed position and a deployed position. Fixed camera housings may also be used. At least one rearward facing camera 20a, 20b (generally, “camera 20”) is arranged respectively within camera arms 16a, 16b. Each arm 16a, 16b may also provide a housing that encloses electronics, e.g., a controller 30 (FIG. 2), that are configured to provide various features of the CMS 15.

The exterior cameras 20a, 20b respectively provide an exterior field of view FOV_{EX1}, FOV_{EX2} that each include at least one of the Class II and Class IV views (FIG. 2), which are legal prescribed views in the commercial trucking industry. The Class II view on a given side of the vehicle 10 is a subset of the class IV view of the same side of the vehicle 10. Multiple cameras also may be used in each camera arm 16a, 16b to provide these views, if desired. Class II and Class IV views are defined in European R46 legislation, for example, and the United States and other countries have similar driver visibility requirements for commercial trucks. Any reference to a “Class” view is not intended to be limiting, but is intended as exemplary for the type of view provided to a display by a particular camera.

First and second video displays 18a, 18b are arranged on each of the driver and passenger sides within the vehicle cab 12 on or near the A-pillars 19a, 19b (generally, A-pillar 19), for example, to display Class II and Class IV views on its respective side of the vehicle 10, which provide rear facing side views along the vehicle 10 that are captured by the exterior cameras 20a, 20b.

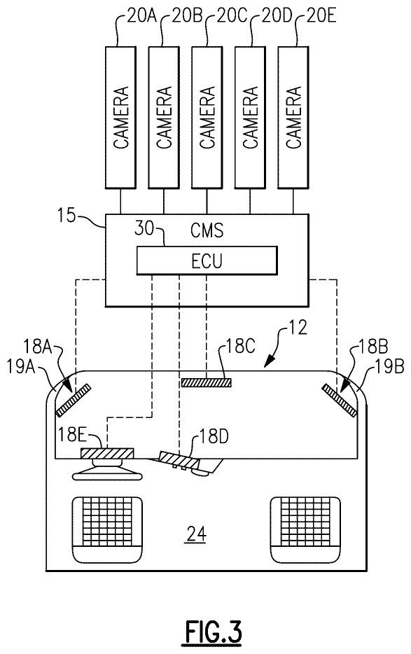

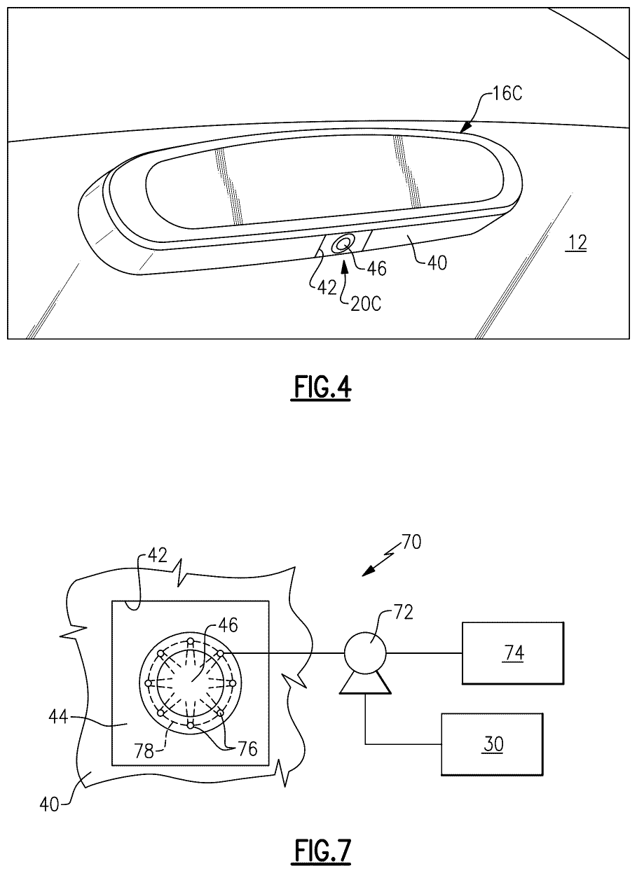

If video of Class V and/or Class VI views are also desired, a camera housing 16c and camera 20c (see, FIGS. 2 and 4) may be arranged at or near the front of the vehicle 10 to provide those views (FIG. 2). A third display 18c arranged within the cab 12 near the top center of the windshield can be used to display the Class V and Class VI views, which are toward the front of the vehicle 10, to the driver. The displays 18a, 18b, 18c (generally, display 18) face a driver region within the cabin 24 where an operator is seated on a driver seat. The location, size and field(s) of view streamed to any particular display may vary from the configurations described in this disclosure and still incorporate the disclosed invention.

If video of Class VIII views is desired, camera housings can be disposed at the sides and rear of the vehicle 10 to provide fields of view including some or all of the Class VIII zones of the vehicle 10. For example, a rear facing trailer camera 20d may be arranged at the rear of the trailer 14 to provide a third field of view FOV_{EX3}, and a fifth wheel camera 20e may be provided at the rear of the tractor 12 to provide a fourth field of view FOV_{EX4} that includes the fifth wheel. In such examples, the third display 18c can include one or more frames displaying the Class VIII views. Alternatively, additional or different displays (e.g. secondary information display 18d and/or driver information display 18e) can be added near the first, second and third displays 18a, 18b, 18c to provide a display of other views.

Although the CMS has been described as having cameras, the CMS may also use LiDar sensor(s), radar sensor(s), and/or ultrasonic sensors to enhance the functionality of the system and provide additional features.

In terms of hardware architecture of the controller 30, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller 30 (FIG. 3) may be a hardware device for executing software, particularly software stored in memory. The controller 30 can be a custom made or commercially available processor, a central processing unit (CPU), an auxiliary processor among several processors associated with the controller, a semiconductor-based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller 30 is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

The disclosure relates to a sensor assembly with a self-cleaning feature. The sensor assembly is suitable for cameras and other sensors such as a lidar sensor, a radar sensor or an ultrasonic sensor. In one example, referring to FIG. 4, the sensor assembly provide the forward tractor camera housing 16c with its camera 20c.

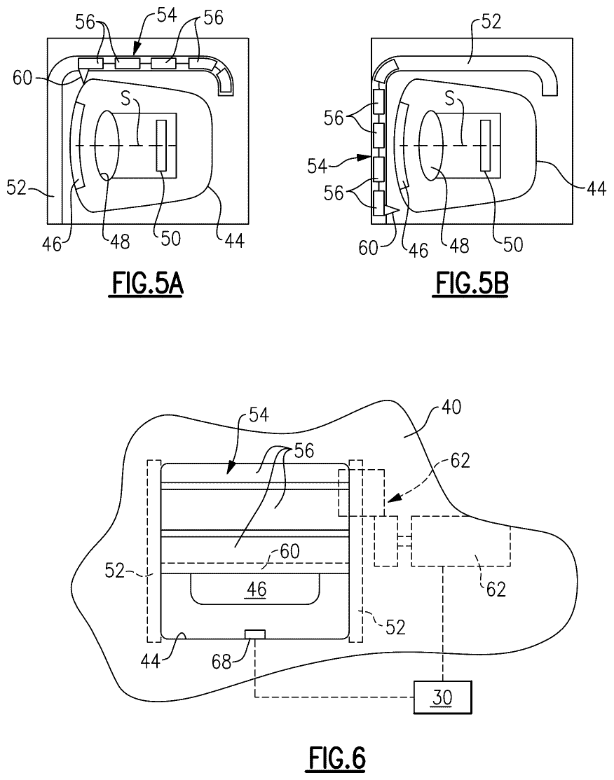

The sensor assembly includes a base 40 mounted to the vehicle 10 and used to house various components, such as the sensor. The sensor is arranged in a sensor housing 44 and is covered by an exterior lens 46 that faces an opening 42 in the base 40. Referring to FIGS. 5A-6, a flexible shutter door 54 is movably supported by tracks 52 to selectively block the opening 42 and expose the exterior lens 46 in response to an actuator 62. As the door 54 is moved between an open position (FIG. 5A) and a closed position (FIG. 5B), the exterior lens 46 is wiped by a wiper 60 mounted to the door to remove debris that may obstruct the sensor and interfere with its desired operation.

Referring to FIGS. 5A and 5B, the sensor housing 44 is arranged within and fixed relative to the base 40 such that it does not move whether operable or inoperable. Thus, there is no risk of the sensor moving out of alignment as is the case with other designs. That is, the sensor and its sensor axis continually remain positioned with respect to the opening 42 to provide a vehicle environmental monitoring signal to the CMS during vehicle operation. Said yet another way, the sensor housing 44 remain fixed in the open position (FIG. 5A), the closed position (FIG. 5B) and a wiping position (FIG. 6).

In the example of a camera (FIG. 5A-5B), the sensor includes an optical lens 48 arranged behind the exterior lens 46. An image capture until 50 is in communication with the controller 30 and provides a vehicle environmental monitoring signal (i.e., stream images) to the CMS 15 during vehicle operation.

As best depicted in FIGS. 5A and 5B, the tracks 52 are arranged in the base 40 at opposing sides of the opening 42. In the example, the tracks 52 have curved portions such that the tracks 52 provide a non-linear path between the closed and open positions. The non-linear path includes transverse (e.g., straight) portions joined by the curved portions. In one example, to improve flexibility of the door 54, multiple discrete slats 56 joined to one another at a joint that permits articulation between adjacent slats 56. In another example, a think flexible material may be used such that joints are not necessary.

The door 54 is constructed from an opaque solid material without a window such that the exterior lens 46 is hidden and not visible behind the door 54 when in the closed position. The door 54 blocks the opening 42 and thus the exterior lens 46 in the closed position to protect the exterior lens 46 from becoming occluded with additional debris and/or damaged. The door 54 has an end to which the wiper 60 is mounted. In one example, the base 40 includes a switch 68 that is configured to detect the end (and thus, the door 54) in the closed position. The door 54 is stowed adjacent to the sensor housing 44 within the base 40 when in the open position.

As shown in FIG. 6, the actuator 62 is arranged in the base 40 and slides the door 54 along the tracks 52 and relative to the base 40 in response to a sensor demand signal from the CMS 15. The actuator 62 may be an electric motor, for example, that is coupled directly to the door 54 or indirectly using a drive connection 64 (e.g., gear train, belt drive or other coupling). The sensor demand signal may be a signal indicating that the exterior lens 46 is obstructed and must be cleaned, the vehicle has started, the vehicle has been turned off, or indicative of another operational state of the vehicle or one of its systems.

Referring to FIG. 7, the sensor assembly may also include a washer system 70 that includes one or more jets or nozzles 76 aimed at the exterior lens 46. In the example shown, the nozzles 76 are fluidly connected to one another by one or more passages 78 and arranged in an array on the sensor housing 44 to circumscribe the exterior lens 46. The washer system 70 has a pump 72 and a fluid reservoir 74 in fluid communication with the nozzles 76 to provide washer fluid to the nozzles 76 to remove debris from the exterior lens 46.

It should be understood that the nozzle(s) may be configured differently than the example shown. For example, the nozzles may be mounted inside the base to spray the exterior lens prior to the sensor being operative. In another example, the nozzle(s) could be mounted to the exterior of the base so that it can spray the exterior lens when operative.

The controller 30 is in communication with the washer system 70 (FIG. 7) the actuator 62 (connection not shown), the switch 68 and the sensor (e.g., FIG. 6). The controller 30 commands the actuator 62 to move the door 54 to the closed position, for example, when a vehicle is in a non-operational state (e.g., engine is shut off). The sensor is then protected within the base. The controller 30 may also command the pump 72 to provide washer fluid to exterior lens 46 at about the same time so that the wiper 60 can more effectively remove debris before the sensor is stowed in the base 40.

In operation, the disclosed sensor assembly removes debris from a by moving the door 54 along the tracks 52 between an open position and a closed position. During movement between these two positions, the wiper 60 slides against the exterior lens 46 (i.e., in the wiping position; FIG. 6) while performing the moving step. The door 54 can then be moved to an operational position (open position) when the vehicle is powered (e.g., engine started).

The disclosed sensor assembly uses a simple technique for cleaning its exterior lens without any complicated motions while providing a very compact arrangement of parts. Since the door 54 is flexible it can be arranged in a more compact configuration. The disclosed configuration improves reliability of the system while also providing an aerodynamic package.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A sensor assembly for a vehicle camera monitor system (CMS), comprising:
a base configured to be mounted to a vehicle, wherein the base has tracks at opposing sides of an opening in the base;
a sensor housing arranged within the base, wherein a sensor has a sensor axis and is arranged within the sensor housing and configured to provide a vehicle environmental monitoring signal to the CMS during vehicle operation, and an exterior lens is operatively supported by the sensor housing and arranged over the sensor at the opening;
a flexible shutter door movably supported by the tracks and configured to selectively block the opening and expose the exterior lens;
a wiper mounted to the door; and
an actuator arranged in the base and configured to, in response to a sensor demand signal from the CMS, slide the door along the tracks between:
a closed position in which door blocks the opening to enclose the exterior lens and the sensor within the base,
an open position in which the door exposes the exterior lens, and wherein the door is stowed adjacent to the sensor housing within the base, and
a wiping position arranged between the closed position and the open position, wherein the wiper is configured to slide across the exterior lens when moving between the closed position and the open position.

2. The sensor assembly of claim 1, wherein the door includes multiple discrete slats joined to one another at a joint that permits articulation between adjacent slats.

3. The sensor assembly of claim 2, wherein the tracks have curved portions such that the tracks provide a non-linear path between the closed and open positions.

4. The sensor assembly of claim 3, wherein the non-linear path includes transverse portions joined by the curved portions.

5. The sensor assembly of claim 1, wherein the door is an opaque solid material without a window, the exterior lens is hidden and not visible behind the door when in the closed position.

6. The sensor assembly of claim 1, wherein the sensor housing is fixed relative to the base.

7. The sensor assembly of claim 6, wherein the sensor housing is configured to remain fixed in the open position, the closed position and the wiping position.

8. The sensor assembly of claim 1, wherein the door has an end, and the wiper is arranged at the end.

9. The sensor assembly of claim 8, wherein the base includes a switch configured to detect the end in the closed position.

10. The sensor assembly of claim 1, wherein the sensor is one of a camera, a lidar sensor, a radar sensor or an ultrasonic sensor.

11. The sensor assembly of claim 1, comprising a washer system including an array of jets provided in the sensor housing about the exterior lens, the washer system has a pump and a fluid reservoir in fluid communication with the jets configured to provide a fluid to the jets to remove debris from the exterior lens.

12. A CMS comprising the sensor assembly of claim 1, further comprising a controller in communication with the actuator and the sensor, the controller configured to move the door to the closed position when a vehicle is in a non-operational state.

13. The CMS of claim 12, wherein the sensor includes an image capture unit configured to provide at least one field of view, and comprising at least one display configured to depict at least portions of the at least one field of view.

14. A method of removing debris from a camera monitor system (CMS) sensor assembly, comprising:
providing sensor housing with a sensor arranged beneath an exterior lens, the sensor housing is arranged within a base including an opening;
moving a flexible shutter door between a closed position and an open position; and
sliding a wiper against the exterior lens in a wiping position while performing the moving step, the wiper position arranged between the closed position and the open position.

15. The method of claim 14, wherein tracks slidably supporting the door have curved portions such that the tracks provide a non-linear path between the closed and open positions, and the non-linear path includes transverse portions joined by the curved portions, and wherein the door includes multiple discrete slats joined to one another at a joint that permits articulation between adjacent slats along the non-linear path during the moving step.

16. The method of claim 15, wherein the door is an opaque solid material without a window, the exterior lens is hidden and not visible behind the door when in the closed position.

17. The method of claim 14, wherein the sensor housing is fixed relative to the base, and the sensor housing is configured to remain fixed in the open position, the closed position and the wiping position.

18. The method of claim 14, wherein the door has an end, and the wiper is arranged at the end.

19. The method of claim 18, wherein the base includes a switch configured to detect the end in the closed position.
